(19) United States
(12) Patent Application Publication
(10) Pub. No.: US 2019/0337827 A1
(43) Pub. Date: Nov. 7, 2019

(54) Apparatus and Method for Aerating Wastewater

(71) Applicant: Somerset Environmental Solutions Inc., Warrendale, PA (US)

(72) Inventor: James D. Oliver, Pittsburgh, PA (US)

(21) Appl. No.: 16/090,676

(22) PCT Filed: Apr. 3, 2017
(86) PCT No.: PCT/US2017/025726

§ 371 Date: Oct. 2, 2018

Related U.S. Application Data
(60) Provisional application No. 62/322,850, filed on Apr. 15, 2016.

(51) Int. Cl. C02F 1/74; B01F 3/04

(52) U.S. Cl. CPC C02F 1/74; B01F 3/04099; B01F 2003/04134; C02F 2201/004; B01F 2003/04872; C02F 2201/005

(57) ABSTRACT

An aeration apparatus includes at least one aerator, a frame fluidly connected to the at least one aerator, and an aeration source fluidly connected to the frame. The aeration source may be configured to deliver air to the at least one aerator via the frame to oxidize fluid held in the at least one aeration chamber.

### CROSS-REFERENCE TO RELATED APPLICATION

This application claims priority to U.S. Provisional Patent Application No. 62/322,850 filed Apr. 15, 2016, the disclosure of which is hereby incorporated in its entirety by reference.

### BACKGROUND OF THE INVENTION

### Field of the Invention

The present invention relates to an apparatus for mixing of liquids and gases and, more particularly, to an apparatus and method for a wastewater aeration treatment.

### Description of Related Art

Many different types of aerators are used for a variety of diverse needs and processes. Several such aerators are used for wastewater treatment. However, many of these aerators have disadvantages to them that do not provide the most efficient aeration of the wastewater.

Surface aerators contain motor driven propellers and are anchored in place on the surface of basins or ponds to agitate wastewater and transfer oxygen. Most surface aerators in use require 25 to 100 horsepower each and most installations have multiple units to fulfill the full aeration requirements. High-energy consumption makes these aerators significantly expensive to operate and maintain at a worksite. Surface aerators also have many moving components in direct contact with the wastewater that is being aerated. This can cause significant time consuming downtime and high maintenance costs. Due to the surface aerators' size, their weight and placement in large bodies of water provides another disadvantage in requiring crane-type equipment to remove the surface aerators for maintenance, repair, or replacement.

Fine bubble aerators are another type of water aeration device. This type of aeration device is placed at the bottom of basins with water depth of 13 to 16 feet. The depth at which these units are placed requires relatively high pressures to overcome the weight of the water above them. High pressure translates into high-energy consumption, which translates into higher costs. The openings in the fine bubble aerators that discharge air into the water are often miniscule in size. This often leads to clogging of these small holes.

Another type of aeration device is a sparging ring. Sparging rings are placed at the bottom of basins at depths of 13 to 16 feet. Sparging rings require relatively high pressure, require high energy usage and high costs. Turbines are used with these devices to break up the size of the air bubbles and to mix the large volumes of liquid contained within the basin. Turbines are high-energy consumption devices, having moving parts in direct contact with the liquid, and require a high amount of maintenance.

Another type of aeration device includes an aspiration stripper. This type of aeration device aspirates free air. Liquid to be aerated is pumped through a plurality of orifices within the unit. In order to aspirate the air, liquid is pumped through these devices at pressures that may exceed 50 psi. High pressures require high energy inputs, which translates to high costs. The small, elongated orifices in the units make them susceptible to clogging. Pre-filtering is often required in this aeration device. This type of aeration device is limited in the amount of aspirated air that is available to transfer oxygen into the liquid. When a process has a high oxygen demand, this type of device often has to recycle pre-processed liquid. The susceptibility to clogging, high-energy consumption, and recycling requirement in high oxygen transfer applications are several disadvantages of the aspiration stripper.

Another type of aeration device is disclosed in U.S. Pat. No. 6,033,562 to Budeit, the disclosure of which is incorporated by reference herein. This type of aeration device is configured for a single pass mass transfer of oxygen into a liquid. Individual aeration modules allow a continuous flow of liquid to be permeated with oxygen as it passes through a successive series of reaction chambers. The continuous flow of liquid is first introduced into an infusion chamber from a pressurized or gravity flow source and is directed under a baffle of the infusion chamber. The continuous flow of liquid passes under the baffle and rises in an adjacent reaction chamber. Oxygen is introduced into the reaction chamber and is transferred into the continuous flow of liquid. The flow of liquid is then propelled over another baffle into a discharge chamber. The aeration device may also introduce chemical reagents into the chambers to break down oil components in the flow of liquid.

### SUMMARY OF THE INVENTION

In view of the foregoing disadvantages with current aeration devices, a need exists for a cost-efficient, reliable wastewater aeration device and method that overcome the shortcomings of the existing aeration devices.

According to one aspect of the disclosure, an aeration apparatus includes at least one aerator, a frame fluidly connected to the at least one aerator, and an aeration source fluidly connected to the frame. The aeration source may be configured to deliver air to the at least one aerator via the frame to oxidize fluid held in the at least one aeration chamber.

The aeration apparatus may also include at least one aeration chamber. The at least one aerator may be positioned within the at least one aeration chamber. A shut-off valve may be positioned in line with the frame. The shut-off valve may be configured for at least two positions, a first position that permits passage of oxygen through the frame and a second position that prevents the passage of oxygen through the frame. A releasable connection may be provided between a portion of the frame and the at least one aerator. The releasable connection may be configured to permit removal of a portion of the frame to which the at least one aerator is connected from a remaining portion of the frame. At least one weighed anchor may be connected to the at least one aerator. The at least one aerator may include at least one aperture defined therein and a meshing positioned around a portion of an outer circumferential surface of the at least one aerator. A pressurized air tank may be fluidly connected to the frame. The pressurized air tank may be configured to supply pressurized air to the frame and at least one aerator. A flexible line may be provided between the at least one aerator and a portion of the frame. At least one U-hook connection may be provided on the frame. The at least one U-hook connection may be configured to assist in positioning the frame relative to the at least one aeration chamber.

In another aspect of the disclosure, an aeration apparatus includes a front wall, a rear wall, a first side wall, a second side wall, and a bottom wall defining an inner cavity, at least two baffles positioned within the inner cavity to define at least three aeration chambers within the inner cavity, and at least one aerator positioned within each aeration chamber, wherein a first baffle extends from the bottom wall to a position below an upper surface of the aeration chamber, and a second baffle extends from the upper surface of the aeration chamber to a position above the bottom wall.

The at least two baffles may include five baffles spaced apart from one another within the aeration apparatus. The baffles may be positioned at alternating heights within the aeration apparatus. The baffles may extend across an entire width of the aeration apparatus. A distance between the first and second baffles may be shorter than a distance between one of the first and second baffles and a third baffle positioned in the aeration apparatus. An inlet port may be defined in the front wall, wherein the second baffle is positioned proximate the inlet port. The baffles may be removably provided in the aeration apparatus. The aeration apparatus may be configured to be transportable between different wastewater sources. An aeration source may be fluidly connected to the aerators to supply a pressurized fluid to the aeration chambers.

In another aspect of the disclosure, a method of aerating wastewater includes positioning an aeration apparatus within a wastewater source; installing a frame and at least one aerator connected to the frame in the aeration apparatus; directing the wastewater into the aeration apparatus; directing the wastewater into a first aeration chamber defined in the aeration apparatus; aerating the wastewater in the first aeration chamber; directing the wastewater into a second aeration chamber; aerating the wastewater in the second aeration chamber; directing the wastewater out of the aeration apparatus; removing the frame and at least one aerator from the aeration apparatus; and removing the aeration apparatus from the wastewater source. The method may further include providing a baffle arrangement between the first and second aeration chambers; and directing the wastewater through the baffle arrangement to move the wastewater from the first aeration chamber to the second aeration chamber.

Further aspects will now be described in the following numbered clauses.

Clause 1: An aeration apparatus, comprising: at least one aerator; a frame fluidly connected to the at least one aerator; and an aeration source fluidly connected to the frame, wherein the aeration source is configured to deliver air to the at least one aerator via the frame to oxidize fluid held in the at least one aeration chamber.

Clause 2: The aeration apparatus as claimed in Clause 1, further comprising at least one aeration chamber, wherein the at least one aerator is positioned in the at least one aeration chamber.

Clause 3: The aeration apparatus as claimed in Clause 1 or 2, further comprising a shut-off valve positioned in line with the frame, wherein the shut-off valve is configured for at least two positions, a first position that permits passage of air through the frame and a second position that prevents the passage of air through the frame.

Clause 4: The aeration apparatus as claimed in any of Clauses 1-3, further comprising a releasable connection provided between a portion of the frame and the at least one aerator, wherein the releasable connection is configured to permit removal of a portion of the frame to which the at least one aerator is connected from a remaining portion of the frame.

Clause 5: The aeration apparatus as claimed in any of Clauses 1-4, further comprising at least one weighed anchor connected to the at least one aerator.

Clause 6: The aeration apparatus as claimed in any of Clauses 1-5, wherein the at least one aerator comprises at least one aperture defined therein.

Clause 7: The aeration apparatus as claimed in any of Clauses 1-6, further comprising a pressurized air tank fluidly connected to the frame, wherein the pressurized air tank is configured to supply pressurized air to the frame and at least one aerator.

Clause 8: The aeration apparatus as claimed in any of Clauses 1-7, further comprising a flexible line provided between the at least one aerator and a portion of the frame.

Clause 9: The aeration apparatus as claimed in any of Clauses 1-8, further comprising at least one U-hook connection provided on the frame, wherein the at least one U-hook connection is configured to assist in positioning the frame relative to the at least one aeration chamber.

Clause 10: An aeration apparatus, comprising: a front wall, a rear wall, a first side wall, a second side wall, and a bottom wall defining an inner cavity; at least two baffles positioned within the inner cavity to define at least three aeration chambers within the inner cavity; and at least one aerator positioned within each aeration chamber, wherein a first baffle extends from the bottom wall to a position below an upper surface of the aeration chamber, and a second baffle extends from the upper surface of the aeration chamber to a position above the bottom wall.

Clause 11: The aeration apparatus as claimed in Clause 10, wherein the at least two baffles comprises five baffles spaced apart from one another within the aeration apparatus.

Clause 12: The aeration apparatus as claimed in Clause 10 or 11, wherein the baffles are positioned at alternating heights within the aeration apparatus.

Clause 13: The aeration apparatus as claimed in any of Clauses 10-12, wherein the baffles extend across an entire width of the aeration apparatus.

Clause 14: The aeration apparatus as claimed in any of Clauses 10-13, wherein a distance between the first and second baffles is shorter than a distance between one of the first and second baffles and a third baffle positioned in the aeration apparatus.

Clause 15: The aeration apparatus as claimed in any of Clauses 10-14, further comprising an inlet port defined in the front wall, wherein the second baffle is positioned proximate the inlet port.

Clause 16: The aeration apparatus as claimed in any of Clauses 10-15, wherein the baffles are removably provided in the aeration apparatus.

Clause 17: The aeration apparatus as claimed in any of Clauses 10-16, wherein the aeration apparatus is configured to be transportable between different wastewater sources.

Clause 18: The aeration apparatus as claimed in any of Clauses 10-17, further comprising an aeration source fluidly connected to the aerators to supply a pressurized fluid to the aeration chambers.

Clause 19: A method of aerating wastewater, comprising: positioning an aeration apparatus within a wastewater source; installing a frame and at least one aerator connected to the frame in the aeration apparatus; directing the wastewater into the aeration apparatus; directing the wastewater into a first aeration chamber defined in the aeration apparatus; aerating the wastewater in the first aeration chamber; directing the wastewater into a second aeration chamber; aerating the wastewater in the second aeration chamber; directing the wastewater out of the aeration apparatus; removing the frame and at least one aerator from the aeration apparatus; and removing the aeration apparatus from the wastewater source.

Clause 20: The method as claimed in Clause 19, further comprising providing a baffle arrangement between the first and second aeration chambers; and directing the wastewater through the baffle arrangement to move the wastewater from the first aeration chamber to the second aeration chamber.

These and other features and characteristics of the aeration apparatus, as well as the method of aeration, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a front perspective view of an aeration apparatus in accordance with one aspect of the present disclosure;

FIG. 2 is a side view of the aeration apparatus of FIG. 1;

FIG. 3 is a top plan view of the aeration apparatus of FIG. 1;

FIG. 4 is a front perspective view of an aerator used in the aeration apparatus of FIG. 1;

FIG. 5 is a front perspective view of the aerator of FIG. 4 including an outer wire meshing;

FIG. 6 is a schematic bottom view depicting a flow of fluid created by the aerator of FIG. 4;

FIG. 7 is a schematic side view depicting another baffle and aerator arrangement according to the present disclosure, and

FIG. 8 is a schematic top view of the baffle and aerator arrangement shown in FIG. 7.

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, ‘longitudinal”, and derivatives thereof shall relate to the invention as it is oriented in the figures. However, it is to be understood that the invention may assume alternative variations and step sequences, except where expressly specified to the contrary. It is also to be understood that the specific devices and processes illustrated in the attached drawings, and described in the following specification, are simply exemplary aspects of the invention. Hence, specific dimensions and other physical characteristics related to the aspects disclosed herein are not to be considered as limiting.

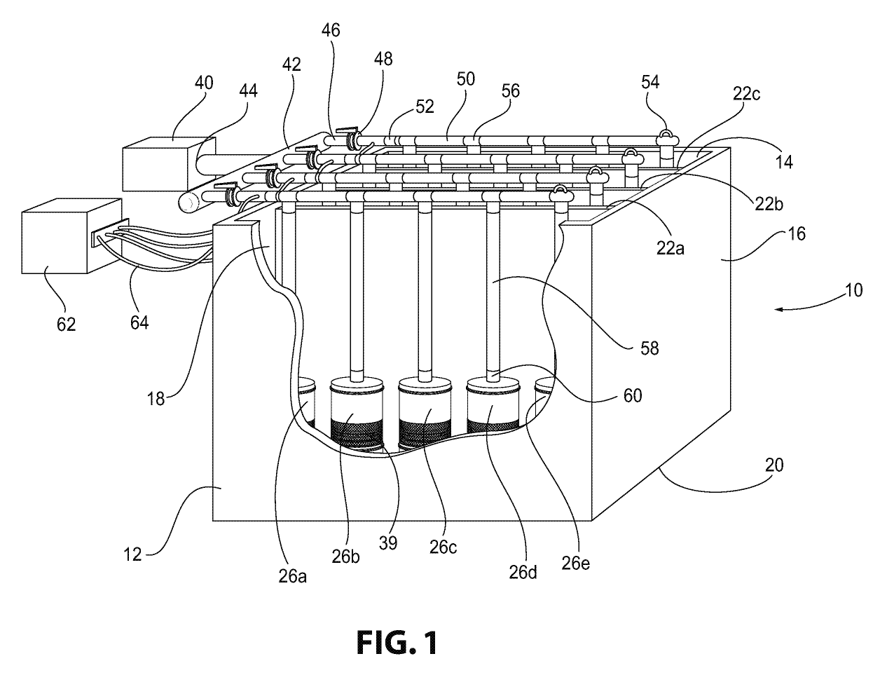

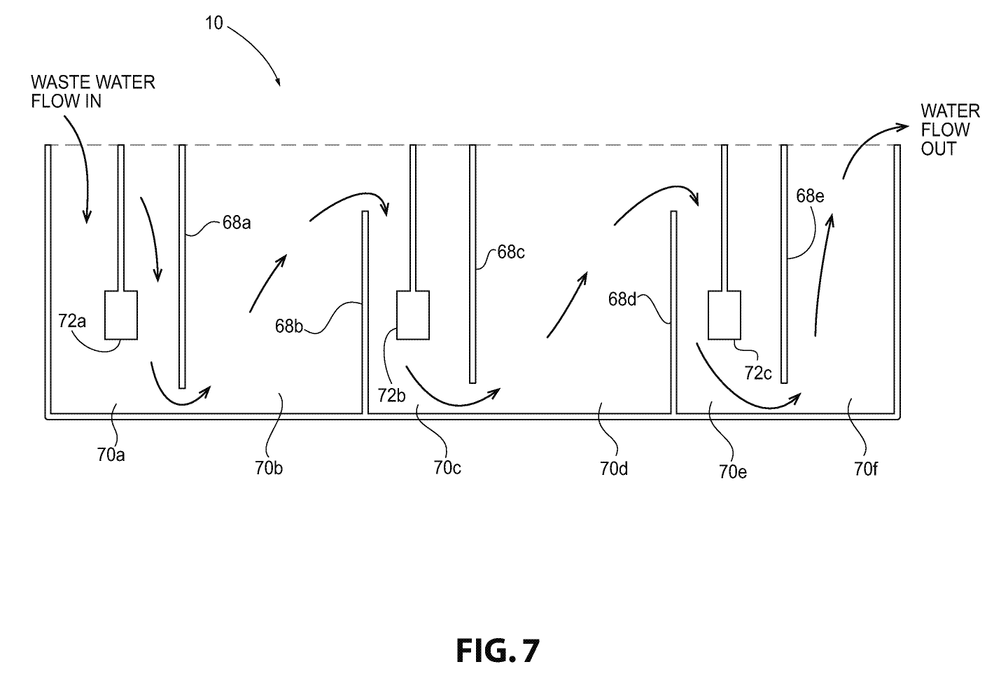

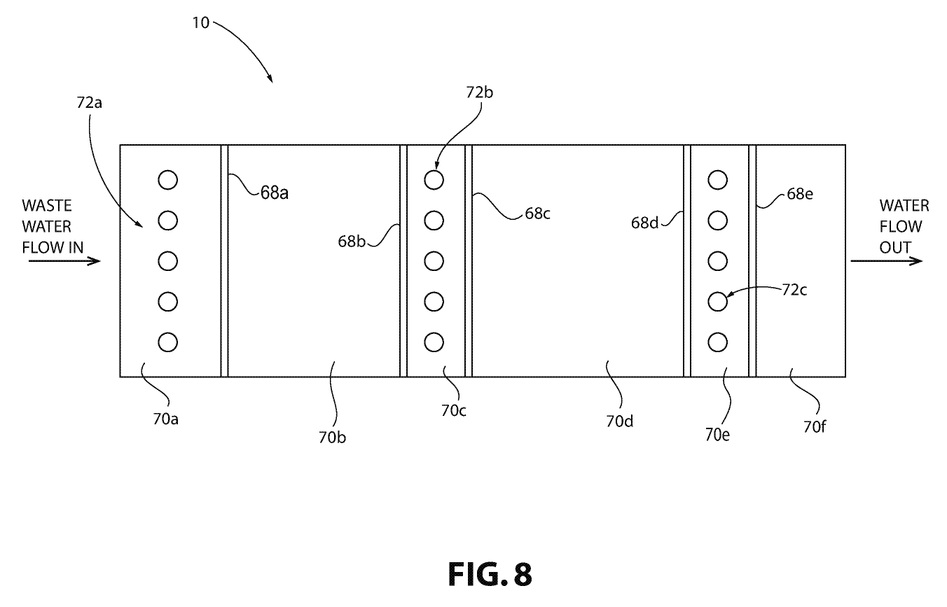

With reference to FIGS. 1-3, an aeration apparatus 10 is described herein below. The aeration apparatus 10 includes a front wall 12, a rear wall 14, and two side walls 16, 18. The walls 12, 14, 16, 18 are connected to one another so as to form a substantially rectangular housing that defines an inner cavity for the aeration apparatus 10. It is also contemplated that the aeration apparatus 10 may have an alternative shape, such as square, triangular, oval, and circular, among others. The aeration apparatus 10 is designed and configured to be transportable between wastewater sources such that an operator can install and remove the aeration apparatus 10 at different work sites, as needed. A bottom surface 20 may be provided at the bottom surface of each wall 12, 14, 16, 18, thereby defining a cavity in the aeration apparatus 10. At least one baffle 22a-c may be provided in the aeration apparatus 10. The at least one baffle 22a-c may be interconnected to the sidewalls 16, 18. The baffles 22a-c may be made of wood, plastic, metal, such as steel, or any other suitably rigid material. In one aspect, three baffles 22a-c are provided in the aeration apparatus 10. In another aspect of the disclosure, shown in FIGS. 7 and 8, at least five baffles 68a-e may be provided in the aeration apparatus 10. It is to be understood, however, more or fewer baffles may be provided in the aeration apparatus 10 according to the needs of the worksite. The baffles 22a-c may extend from a top surface of the aeration apparatus 10 to a position above the bottom surface of the aeration apparatus 10. The baffles 22a-c may also extend from the bottom surface of the aeration apparatus 10 to a position underneath the top surface of the aeration apparatus 10. In one aspect, the baffles 22a-c may alternate such that a first baffle 22a extends from a top surface of the aeration apparatus 10 to a position above the bottom surface of the aeration apparatus 10 and a second baffle 22b extends from the bottom surface of the aeration apparatus 10 to a position underneath the top surface of the aeration apparatus 10. The baffles 22a-c are spaced apart from one another to define aeration chambers 24a-d therebetween. The spacing of the baffles 22a-c may be based on the concentration of wastewater along the length of the worksite. The baffles 22a-c may be spaced apart at approximately 3 foot intervals at a worksite that includes highly concentrated wastewater. Alternatively, the baffles 22a-c may be spaced further apart at a worksite that has a lower concentration wastewater. The baffles 22a-c assist in increasing the retention of wastewater in the aeration chambers 24a-d and reduce the likelihood of dead zones in the aeration chambers 24a-d that would keep the wastewater stationary without circulating throughout the aeration apparatus 10. In an event in which a worksite requires multiple aeration chambers in the aeration apparatus 10 to provide significant volumes of oxygen to the wastewater in the worksite, more baffles may be used to create more aeration chambers in the aeration apparatus 10. The wastewater may enter the aeration apparatus 10 over the front wall 12 or, alternatively, through an inlet port (now shown) provided in the front wall 12. As the wastewater enters the aeration apparatus 10, the wastewater flows over and under the respective baffles 22a-c and then exits the aeration apparatus 10 over the rear wall 14 or through an outlet port (not shown) in the rear wall 14. The baffles 22a-c may be formed integral with the aeration apparatus 10 as a monolithic structure, fastened to the aeration apparatus 10, adhesively connected to the aeration apparatus 10, or slidably held in the aeration apparatus 10 using a slot arrangement in which the aeration apparatus 10 includes recesses to receive the baffles 22a-c. In one aspect, the baffles 22a-c are removably inserted in the aeration apparatus 10. It is also contemplated that the baffles 22a-c may be permanently held within the aeration apparatus 10. In another aspect of the disclosure, the baffles 22a-c may float within the aeration apparatus 10 without connection to the aeration apparatus 10. For example, each baffle 22a-c may include a flotation attachment on a top portion and a weight bottom to keep the baffle 22a-c held in place within the aeration apparatus 10. In this aspect, guides could also be provided on the sides of the baffles 22a-c to removably connect the baffles 22a-c to the sides of the aeration apparatus 10.

Another baffle arrangement is shown in FIGS. 7 and 8. In this aeration apparatus 10, at least five baffles 68a-e are used to create six chambers 70a-f. As will be described in more detail below, a row of aerators 72a-c may be provided in three of the chambers 70a, 70c, 70e to create aeration chambers. The remaining chambers 70b, 70d, 70f allow the wastewater to move through the aeration apparatus 10 between the aeration chambers 70a, 70c, 70e. As shown in FIG. 7, as wastewater flows into the aeration apparatus 10, the wastewater enters a first aeration chamber 70a. As the wastewater enters the first aeration chamber 70a, the wastewater contacts the first baffle 68a to direct the wastewater to the bottom of the aeration apparatus 10. The first baffle 68a may extend from a top surface of the aeration apparatus 10 to a position above the bottom surface of the aeration apparatus 10 to leave a gap between the bottom of the baffle 68a and the bottom surface of the aeration apparatus 10. The wastewater passes underneath the first baffle 68a and is directed upwards in the aeration apparatus 10 towards the second baffle 68b. The second baffle 68b may extend from the bottom surface of the aeration apparatus 10 to a position below the top surface of the aeration apparatus 10 to leave a gap between the top of the second baffle 68b and the top surface of the aeration apparatus 10. The wastewater is then directed towards the bottom of the aeration apparatus 10 by contacting the third baffle 68c. The wastewater moves downwardly through the second aeration chamber 70c, which supplies oxygen to the wastewater. The third baffle 68c may extend from a top surface of the aeration apparatus 10 to a position above the bottom surface of the aeration apparatus 10 to leave a gap between the bottom of the third baffle 68c and the bottom surface of the aeration apparatus 10. The wastewater is directed underneath the third baffle 68c and into the next chamber 70d. As shown in FIG. 7, a distance between the second and third baffles 68b, 68c is shorter than a distance between either the first baffle 68a and the second baffle 68c or a distance between the third baffle 68c and the fourth baffle 68d. The wastewater is then directed upwards through the next chamber 70d by the fourth baffle 68d. The fourth baffle 68d may extend from the bottom surface of the aeration apparatus 10 to a position below the top surface of the aeration apparatus 10 to leave a gap between the top of the fourth baffle 68d and the top surface of the aeration apparatus 10. The wastewater is directed over the fourth baffle 68d. The wastewater is then directed downwards through the aeration chamber 70e by contacting the fifth baffle 68e. The fifth baffle 68e may extend from a top surface of the aeration apparatus 10 to a position above the bottom surface of the aeration apparatus 10 to leave a gap between the bottom of the fifth baffle 68e and the bottom surface of the aeration apparatus 10. As the wastewater moves through the aeration chamber 70e, oxygen is supplied to the wastewater. The wastewater is then directed underneath the fifth baffle 68e. The wastewater is finally directed upwards through the last chamber 70f and out of the aeration apparatus 10. In one aspect, the baffles 68a-68e are positioned at alternating heights within the aeration apparatus 10. In one aspect, the baffles 68a-68e extend across the entire width of the aeration apparatus 10.

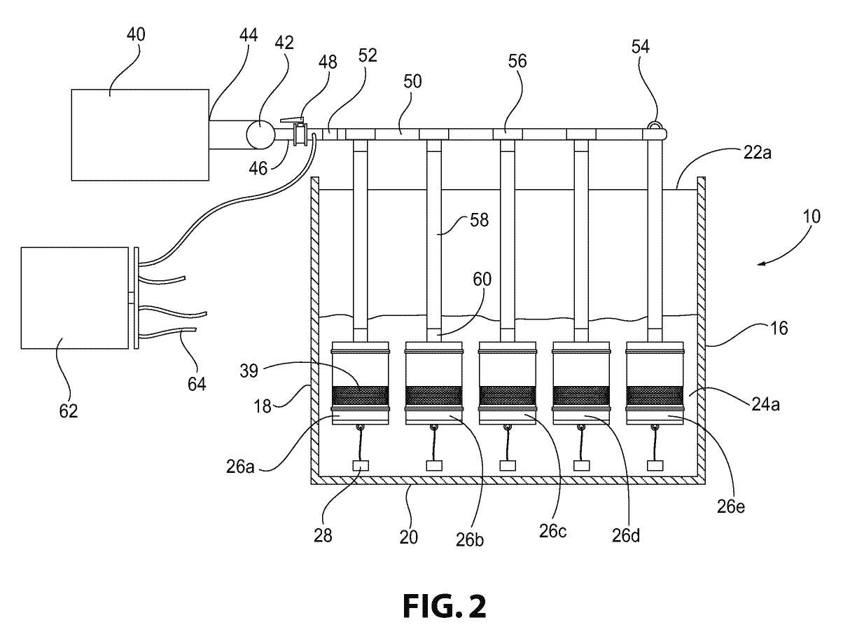

At least one aerator 26a-e may be provided in each aeration chamber 24a-d. As shown in FIGS. 1-3, however, it is also contemplated that at least five aerators 26a-e may be provided in each aeration chamber 24a-d. One of ordinary skill in the art will also readily understand that the total number of aerators can be adjusted according to the needs of each particular worksite. As shown in FIG. 2, the aerators 26a-e are suspended in the aeration chambers 24a-d and are configured to provide a steady supply of oxygen to the aeration chambers 24a-d. In one aspect, an anchor weight 28 may hang from a bottom surface of each aerator 26a-e to prevent the aerators 26a-e from floating to the top surface of the aeration apparatus 10. The weight of each anchor weight 28 may be adjusted according to the desired height of the aerators 26a-e in the aeration chambers 24a-d. As shown in FIGS. 7 and 8, one aerator 72a may be positioned between a wall of the aeration apparatus 10 and the first baffle 68a. A second aerator 72b may be positioned between the second baffle 68b and the third baffle 68c. A third aerator 72c may be positioned between the fourth baffle 68d and the fifth baffle 68e.

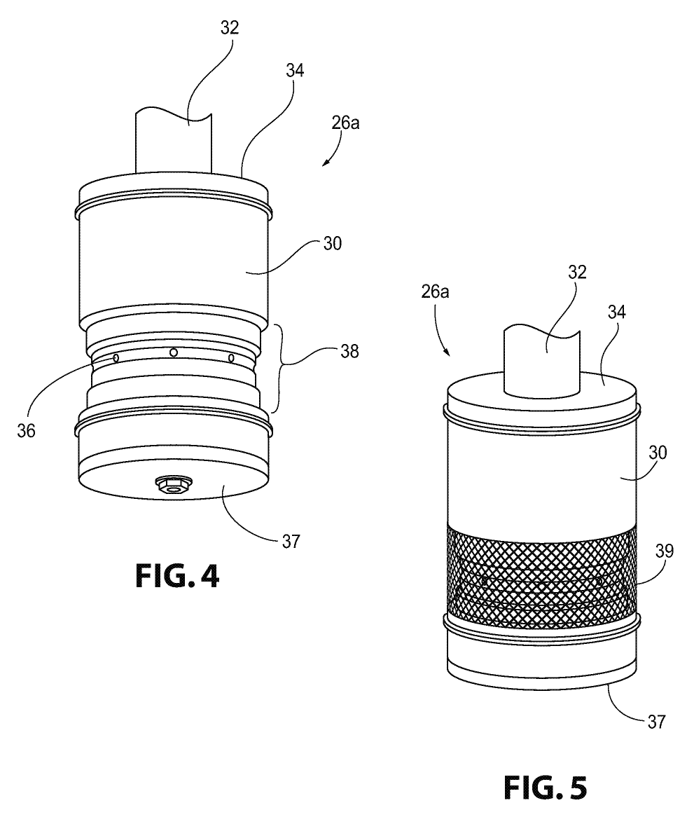

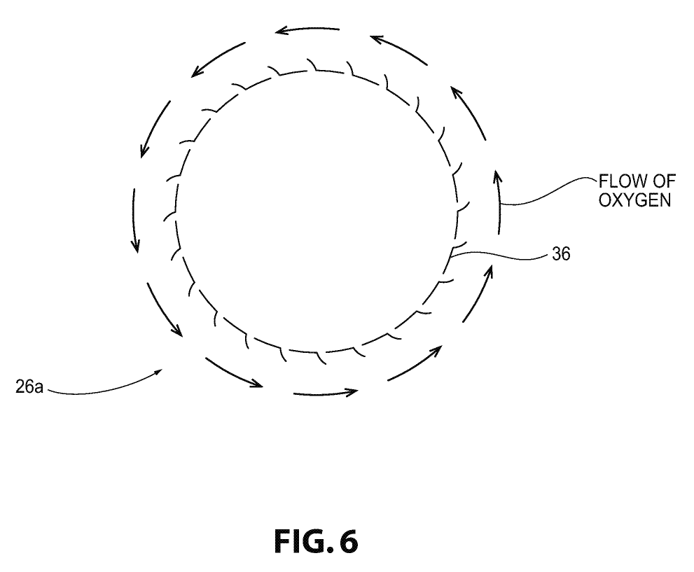

As shown in FIGS. 4 and 5, each aerator 26a-e may include a cylindrical body 30 and an inlet port 32 provided on a top surface 34 of the aerator 26a-e. The inlet port 32 may be in fluid communication with a source of high-volume, low-pressure oxygen. The cylindrical body 30 may have a plurality of apertures 36 arranged in a recessed portion 38 of the cylindrical body 30. The high-volume, low-pressure oxygen is supplied to the aeration chambers 24a-d via the apertures 36 in the aerators 26a-e. It is contemplated that any number of aperture arrangements may be provided in the cylindrical body 30. As shown in FIG. 6, the apertures 36 may be defined in the aerators 26a-e to create a swirling flow of oxygen around the aerators 26a-e. The apertures 36 may create a circumferential flow of oxygen around the aerators 26a-e. A solid plate 37 may be attached to a bottom surface of the aerators 26a-e to assist in keeping the aerators 26a-e submerged in the wastewater of the aeration chambers 24a-d. The solid plate 37 may be made of steel and may be attached to the aerators 26a-e using a fastener, such as a bolt. As shown in FIG. 5, a meshing 39 may be provided over the recessed portion 38 of the cylindrical body 30 to filter out any metal precipitates or any other objects in the aeration chambers 24a-d that may flow into the aerators 26a-e. It is also contemplated that the meshing 39 may not be provided over the recessed portion 38 of the cylindrical body 30. During aeration of the wastewater, a volume of air is added into the wastewater to allow aerobic bio-degradation of the pollutant components. Unlike chemical treatment which uses chemicals to react and stabilize contaminants in the wastewater stream, biological treatment uses microorganisms that occur naturally in wastewater to degrade wastewater contaminants

Oxygen may be injected into the aeration apparatus 10 from a blower 40 (also referred to as an aeration source) or another similar pressurized source. A rigid frame 42 is provided on an outlet 44 of the blower 40 to direct the pressurized oxygen to each aeration chamber 24a-d. The blower 40 may be provided separate from the aeration device 10 or may be an integral component of the aeration device 10. The blower 40 may be manually activated or remotely activated using a remote device. The blower 40 may also include different settings to adjust the volume and/or pressure of the oxygen that is supplied to the aeration device 10. The frame 42 may have several outlets 46 that include a shut-off valve 48 to control which aeration chamber 24a-d receives pressurized oxygen. In one aspect, the shut-off valves 48 may be butterfly-type shut-off valves. It is also contemplated that alternative types of shut-off valves may be used to control the flow of pressurized oxygen to the aeration chambers 24a-d. Each outlet 46 of the frame 42 is connected to a flexible line 50 that extends over the corresponding aeration chamber 24a-d. In one aspect the flexible line 50 is made of flexible PVC. In one aspect, the flexible line 50 is made of a flexible PVC with a rigid PVC helix. It is also contemplated that the flexible line 50 may be rigid. The flexible lines 50 extend from one side wall 16 to the opposing side wall 18 of the aeration device 10. Each flexible line 50 may include a releasable connection 52 that permits easy connection/disconnection of the flexible line 50 from the frame 42. The releasable connection 52 enables an operator to release the flexible line 50 from the frame 42 for cleaning, maintenance, or installation of a new flexible line 50. As shown in FIG. 2, a U-hook 54 may also be provided on a top surface of the flexible line 50. The U-hook 54 may be configured for attachment to a pull line (not shown) to position the flexible line 50 in a desired location within the aeration apparatus 10. Although a U-hook 54 is shown in connection with the aeration apparatus 10, it is to be understood that any type of connection member may be used to permit the attachment of a pull line to the flexible line 50.

As best shown in FIG. 2, each flexible line 50 includes a rigid T-connection 56 for each aerator 26a-e that is provided on the flexible line 50. The T-connection 56 may be made from an HDPE (High Density Polyethylene) material. Another flexible line 58 extends downwardly from the T-connection 56 to connect the aerators 26a-e with the flexible line 50. It is to be understood that a rigid line could also be used in place of the flexible line 58. By using the flexible line 58, the aerators 26a-e are given more freedom to move within the aeration chambers 24a-d, thereby reducing stress on the aerators 26a-e and the flexible lines 50, 58 that each aerator 26a-e is connected to. The end of the flexible line 58 that is connected to each aerator 26a-e may include a rigid connection member 60 to connect the flexible line 58 to the aerator 26a-e. The connection member 60 ensures a tight, secure connection between the flexible line 58 and the aerator 26a-e. By providing the foregoing connection arrangement for the aeration apparatus 10, the blower 40 may direct oxygen to each aerator 26a-e via the frame 42, the flexible line 50, and the other flexible line 58.

In one aspect, the aerators 26a-e, the flexible lines 58, the T-connections 56, the flexible lines 50, the releasable connections 52, and the frame 42 may be provided as a separate unit from the aeration apparatus 10 so that these components can be used in any pre-existing wastewater structure, stream, or water source to provide aeration therein. Therefore, the arrangement may be transported to a water source or wastewater structure and may be installed to aerate the water source. The arrangement does not need to include the aeration apparatus 10.

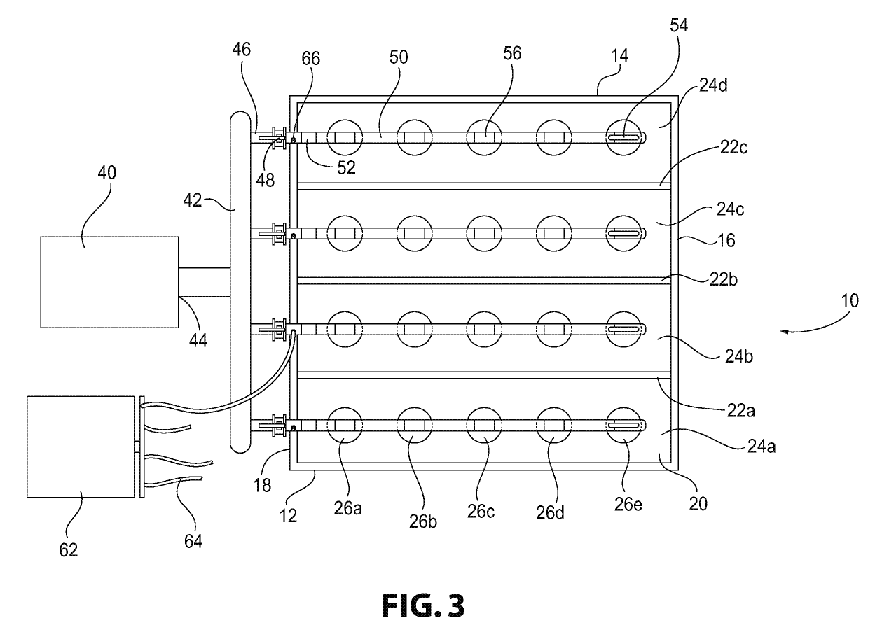

With reference to FIG. 3, another feature of the aeration apparatus 10 is described. A pressurized air tank 62 may be fluidly connected to each flexible line 50 of the aeration apparatus 10 to assist in cleaning the flexible lines 50 and aerators 26a-e. A plurality of hoses 64 may be fluidly connected to the pressurized air tank 62 to connect the pressurized air tank 62 to the flexible lines 50. In one aspect, a hose 64 is provided for each flexible line 50 in the aeration apparatus 10. In another aspect, only one hose 64 is provided in the aeration apparatus 10. The single hose 64 may be used for connection to each flexible line 50 separately. A nipple 66 may be provided on each flexible line 50 to provide easy connection/disconnection of the hose 64 on the flexible line 50. During operation of the aeration apparatus 10, the flexible lines 50, 58 and/or aerators 26a-e may become clogged or dirty and will need to be cleaned to ensure proper operation of the aeration apparatus 10. The pressurized air tank 62 may be used to supply pressurized air (approximately 50-150 psi) to the clogged or dirty flexible lines 50, 58 to blow out and clean the flexible lines 50, 58, thereby removing any debris or objects lodged in the flexible lines 50, 58. In one aspect, a hose 64 may be connected to each flexible line 50 so that all of the flexible lines 50, 58 in the aeration apparatus 10 may be blown out at the same time. In another aspect, a hose 64 may only be connected to one pair of flexible lines 50, 58 so the flexible lines 50, 58 can be blown out, while the rest of the flexible lines 50, 58 in the aeration apparatus 10 can continue to oxidize the wastewater in the remaining aeration chambers 24a-d.

With reference to FIGS. 2 and 3, a description of the aeration process that is employed by the aeration apparatus 10 is provided. A similar aeration process is also shown in FIGS. 7 and 8. Wastewater to be processed in the aeration apparatus 10 is introduced into the aeration chambers 24a-d from a pressurized or gravity flow source. The wastewater flows into the aeration chambers 24a-d to fill each aeration chamber 24a-d and submerge the aerators 26a-e therein. High-volume, low-pressure oxygen is directed from the blower 40 to the aerators 26a-e through the frame 42 and flexible lines 50, 58. The oxygen is dispelled from the aerators 26a-e through the apertures 36 into the wastewater that is flowing into the aeration chambers 24a-d. The impact of the aerated wastewater against the sides of the aeration chambers 24a-d, the thrust of colliding flow created by the multiple aerators 26a-e in the same aeration chamber 24a-d, the upward direction of the expelled oxygen, and the turbulence and upheaval caused by the large volume of air combine to transfer oxygen into the wastewater. Further, the large volume of oxygen assists in precipitating any dissolved metals in the wastewater. After the wastewater has been oxidized by the aerators 26a-e, the remaining liquid is expelled from the aeration apparatus 10, thereby providing clean oxidized water to a downstream location. By using high-volume, low-pressure air, the operating energy and costs of the aeration apparatus 10 are greatly reduced.

The size and number of aerators 26a-e and apertures 36 are variables that are governed by the volume and pressure output of the blower 40, the depth of immersion of the aerators 26a-e in the wastewater, and the size of the aeration chambers 24a-d. The requisite volume and pressure of oxygen are governed by the amount of flow, the oxygen demand, and depth of wastewater in the aeration chambers 24a-d. One of ordinary skill in the art will readily identify the requirements for these inter-related variables of the aeration apparatus 10.

While various aspects of the aeration apparatus 10 were provided in the foregoing description, those skilled in the art may make modifications and alterations to these aspects without departing from the scope and spirit of the invention. For example, it is to be understood that this disclosure contemplates that, to the extent possible, one or more features of any aspect can be combined with one or more features of any other aspect. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. An aeration apparatus, comprising:
at least one aerator;
a frame fluidly connected to the at least one aerator; and
an aeration source fluidly connected to the frame,
wherein the aeration source is configured to deliver air to the at least one aerator via the frame to oxidize fluid held in the at least one aeration chamber.

2. The aeration apparatus as claimed in claim 1, further comprising at least one aeration chamber,
wherein the at least one aerator is positioned in the at least one aeration chamber.

3. The aeration apparatus as claimed in claim 1, further comprising a shut-off valve positioned in line with the frame,
wherein the shut-off valve is configured for at least two positions, a first position that permits passage of air through the frame and a second position that prevents the passage of air through the frame.

4. The aeration apparatus as claimed in claim 1, further comprising a releasable connection provided between a portion of the frame and the at least one aerator,
wherein the releasable connection is configured to permit removal of a portion of the frame to which the at least one aerator is connected from a remaining portion of the frame.

5. The aeration apparatus as claimed in claim 1, further comprising at least one weighed anchor connected to the at least one aerator.

6. The aeration apparatus as claimed in claim 1, wherein the at least one aerator comprises at least one aperture defined therein.

7. The aeration apparatus as claimed in claim 1, further comprising a pressurized air tank fluidly connected to the frame,
wherein the pressurized air tank is configured to supply pressurized air to the frame and at least one aerator.

8. The aeration apparatus as claimed in claim 1, further comprising a flexible line provided between the at least one aerator and a portion of the frame.

9. The aeration apparatus as claimed in claim 1, further comprising at least one U-hook connection provided on the frame, wherein the at least one U-hook connection is configured to assist in positioning the frame relative to the at least one aeration chamber.

10. An aeration apparatus, comprising:
a front wall, a rear wall, a first side wall, a second side wall, and a bottom wall defining an inner cavity;
at least two baffles positioned within the inner cavity to define at least three aeration chambers within the inner cavity; and
at least one aerator positioned within each aeration chamber,
wherein a first baffle extends from the bottom wall to a position below an upper surface of the aeration chamber, and a second baffle extends from the upper surface of the aeration chamber to a position above the bottom wall.

11. The aeration apparatus as claimed in claim 10, wherein the at least two baffles comprises five baffles spaced apart from one another within the aeration apparatus.

12. The aeration apparatus as claimed in claim 11, wherein the baffles are positioned at alternating heights within the aeration apparatus.

13. The aeration apparatus as claimed in claim 10, wherein the baffles extend across an entire width of the aeration apparatus.

14. The aeration apparatus as claimed in claim 10, wherein a distance between the first and second baffles is shorter than a distance between one of the first and second baffles and a third baffle positioned in the aeration apparatus.

15. The aeration apparatus as claimed in claim 10, further comprising an inlet port defined in the front wall,
wherein the second baffle is positioned proximate the inlet port.

16. The aeration apparatus as claimed in claim 10, wherein the baffles are removably provided in the aeration apparatus.

17. The aeration apparatus as claimed in claim 10, wherein the aeration apparatus is configured to be transportable between different wastewater sources.

18. The aeration apparatus as claimed in claim 10, further comprising an aeration source fluidly connected to the aerators to supply a pressurized fluid to the aeration chambers.

19. A method of aerating wastewater, comprising:
positioning an aeration apparatus within a wastewater source;
installing a frame and at least one aerator connected to the frame in the aeration apparatus;
directing the wastewater into the aeration apparatus;
directing the wastewater into a first aeration chamber defined in the aeration apparatus;
aerating the wastewater in the first aeration chamber;
directing the wastewater into a second aeration chamber;
aerating the wastewater in the second aeration chamber;
directing the wastewater out of the aeration apparatus;
removing the frame and at least one aerator from the aeration apparatus; and
removing the aeration apparatus from the wastewater source.

20. The method as claimed in claim 19, further comprising providing a baffle arrangement between the first and second aeration chambers; and
directing the wastewater through the baffle arrangement to move the wastewater from the first aeration chamber to the second aeration chamber.
